(19) United States
(12) Patent Application Publication
(10) Pub. No.: US 2023/0099839 A1
(43) Pub. Date: Mar. 30, 2023

(54) Charging Station Information System And Method For Dynamic Provision Of Information About Charging Stations

(71) Applicant: Audi AG, Ingolstadt (DE)

(72) Inventor: Benedikt NILGES, lngolstadt (DE)

(73) Assignee: Audi AG, Ingolstadt (DE)

(21) Appl. No.: 17/935,403

(22) Filed: Sep. 26, 2022

(30) Foreign Application Priority Data
Sep. 27, 2021 (DE) 10 2021 124 838.8

(51) Int. Cl. B60L 53/30; B60L 53/66; B60L 53/62; B60L 53/63

(52) U.S. Cl. CPC B60L 53/305; B60L 53/66; B60L 53/62; B60L 53/63

(57) ABSTRACT

The present disclosure relates to a charging station information system for dynamically providing information about charging stations wherein each charging station is assigned at least one identification parameter and one position parameter of the assigned charging point wherein at least one charging station is designed to determine the occupancy state of the charging station. Multiple vehicles comprise a first subset equipped with a communication device for wireless communication and a second subset not equipped with a communication device for wireless communication. Multiple charging stations are networked in a wired manner and configured to exchange at least the respective identification parameter and the determined occupancy state as charging-relevant data, and wherein at least one charging station networked in a wired manner is configured to wirelessly transmit the charging-relevant data together with the respective position parameters of the assigned charging points to the first subset of vehicles.

### TECHNICAL FIELD

The present disclosure relates to a charging station information system for dynamically providing information about charging stations, comprising a multiplicity of charging stations, wherein each charging station is assigned at least one identification parameter and one position parameter of the assigned charging point, wherein at least some of the charging stations are designed to determine at least their occupancy state. Said charging station information system further comprises a multiplicity of vehicles, wherein the multiplicity of vehicles comprises a first subset equipped with a communication device for wireless communication and a second subset not equipped with a communication device for wireless communication. The present disclosure also relates to a corresponding method for dynamically providing information about charging stations in a charging station information system.

### BACKGROUND

Providers of charging stations or also map services frequently offer different information about charging options via corresponding apps. However, this information usually only contains rough guide values for the utilization of the respective charging stations, and even this information is often imprecise.

At the same time, the number of registrations of electrically powered vehicles is increasing and will probably increase growth in the charging infrastructure in the future, so that at least initially the relative ratio of charging options to vehicles will worsen.

From DE 10 2015 210 325 A1, which was used to formulate the preambles of the independent claims, a method for monitoring at least one electric charging station using a vehicle-external central computer with regard to availability for a vehicle user is known. The availability is determined based on a property data record which indicates a current occupancy of the at least one charging station due to a current charging process. A station server is provided which can receive station data from a plurality of charging stations. The system can further comprise a vehicle server arranged at the manufacturer, which is designed to receive the vehicle data from a plurality of vehicles. The vehicle server can be operated by a manufacturer of the plurality of vehicles. The vehicle server can be designed to store and update the data records for charging stations from a plurality of different operators. In particular, the vehicle data can be evaluated for this purpose. In addition, station data can be received and evaluated directly from a charging station or indirectly via a station server.

DE 10 2013 014 527 A1 discloses a method for dynamically providing information regarding an electric charging station for a vehicle user via a mobile station. In this case, information about charging stations is stored in a central computer.

DE 10 2019 005 622 A1 relates to a method for providing information regarding a charging option for a driver of an electric vehicle. Occupancy information for at least one charging station with regard to the expected standing times of a preceding user is transmitted to the driver of the electric vehicle. The information provided is stored in an external database or in a backend and can be accessed and provided from said database at any time.

### BRIEF DESCRIPTION OF DRAWINGS/FIGURES

FIG. 1 shows a schematic representation to explain a charging station information system according to the present disclosure; and

FIG. 2 shows a signal flow graph to explain an embodiment of a method according to the present disclosure for dynamically providing information about charging stations.

### DETAILED DESCRIPTION

The problem addressed by the present present disclosure is that of allowing a user to plan in a forward-looking manner a charging stay at a charging station in a way that saves resources as much as possible.

This problem is solved by the subject matter of the independent claims.

The present present disclosure is based on the knowledge that the charging-relevant information is collected decentrally, i.e., without using a central server device, and made available wirelessly at least to vehicles with a charging request.

In a first aspect of the present disclosure, said charging-relevant information is sent by at least some charging stations. In detail: According to this first aspect, the charging station information system of the type in question is developed such that a plurality of charging stations of at least one charging park is networked in a wired manner and designed to exchange at least the identification parameter of the respective charging station and the determined occupancy state as charging-relevant data. At least some of these charging stations networked in a wired manner are also designed to wirelessly transmit the charging-relevant data together with the respective position parameters of the assigned charging points to vehicles of the first subset. Within the scope of the present disclosure, position-based routing is preferred for wireless transmission, also known under the name GeoNetworking, see hereto ETSI EN 302 636, in particular ETSI EN 302 636-1, ETSI EN 302 636-3, and ETSI EN 302 636-4-1.

According to a second aspect of the present disclosure, the sending takes place by means of at least one vehicle connected to a charging station networked in a wired manner. In detail: Accordingly, a charging station information system of the type in question is developed such that a plurality of charging stations of at least one charging park is networked in a wired manner and designed to exchange at least the respective identification parameter and the determined occupancy state as charging-relevant data. In this case, at least some of these charging stations networked in a wired manner are designed to transmit the charging-relevant data together with the position parameters of the assigned charging points via the respective charging cable to respective vehicles of the first subset connected thereto. At least one connected vehicle of the first subset is designed to wirelessly transmit the charging-relevant data together with the position parameters of the assigned charging points to vehicles of the first subset.

According to the present disclosure, the charging-relevant data are collected or determined within the charging park and sent in a charging park-specific and position-related manner, i.e., sent to vehicles in the vicinity of the charging park, for which this charging park is potentially suitable for charging due to the distance. Such charging park-specific information of different charging parks can then be collected in the respective motor vehicles and optionally displayed to a driver for selection and reservation. In this way, the provision of a central server device or a backend server, including the associated computing and storage capacities and, if applicable, data security measures, can be omitted. In this respect, the costs for an operator of a charging park can be kept low and these cost savings can be passed on to the user via the charging price.

The present disclosure also leads to an increase in convenience for users due to early meaningful information, to better utilization of charging parks, to avoidance of long queues for those who want to charge and allows for a targeted route guidance of unoccupied charging stations at the time of arrival.

An advantageous development is characterized in that the plurality of charging stations is distributed over a plurality of charging parks, wherein at least a plurality of charging stations in each charging park is networked in a wired manner. Wired networking can be implemented more cost-effectively than wireless networking.

The charging-relevant data preferably also comprise at least one data element from the following group of data elements: position of at least one unoccupied charging station networked in a wireless manner, position and time of the end of a current charging process of at least one charging station networked in a wired manner, charging point size or actually available charging point size of at least one charging station, and maximum possible charging capacity of at least one charging station. A potential user can thus receive early information about the utilization and charging times of the vehicles being charged and optimally plan the charging stop accordingly. In the case of a plurality of charging alternatives, the user can select and reserve the best alternative at an early stage or postpone the charging stop.

In particular, as part of “Mobility as a Service,” vehicles can thus independently plan and carry out a charging process with particularly short or no waiting time in periods that have not been booked in advance.

Particularly preferably, at least one vehicle coupled to a charging station is designed to determine the occupancy state of at least one adjacent charging point assigned to another charging station, in particular a charging station networked in a wireless manner, by means of at least one onboard sensor device and to transmit said occupancy state as part of the charging-relevant data. This measure takes into account the fact that vehicles sometimes park or remain parked in charging points without being coupled to a charging station for charging. Since the occupancy state of a charging station is determined in the prior art by querying whether a vehicle is connected to the respective charging station via a charging cable, charging stations are determined as unoccupied and marked as “free” for potential users, even though they actually cannot be used to charge a vehicle other than the one located on the charging point. This can occur if, for example, a user visits the restaurant region of the associated charging park after a charging process and spends a relevant amount of time in said restaurant region. Onboard sensor devices that can be used for this purpose are already present in many vehicles, for example camera devices, radar devices, and the like.

At least one vehicle coupled to a charging station is also preferably designed to determine the actually available charging point size of at least one adjacent charging point assigned to another charging station, in particular a charging station networked in a wireless manner, by means of at least one onboard sensor device and to transmit said charging point size as part of the charging-relevant data. This measure takes into account the fact that vehicles are coupled to a first charging station to carry out a charging process, but, due to their size or an unfortunate parking process, they partially cover the charging point assigned to an adjacent charging station, so that the full charging point size of this second charging station is not available for a vehicle to be charged. If the charging point, which is assigned to the second charging station in this example, is made available without restrictions, it is possible that the available space is no longer sufficient to park any type of vehicle with a charging request. By determining and transmitting the actually available charging point size, vehicles that will find enough space due to their size can reserve or drive to the corresponding charging point. Vehicles for which the actually available charging point size is not sufficient can look for alternatives in good time and avoid an unsuccessful journey.

In order to identify the adjacent charging points, it is preferred that a position parameter of a charging point of an adjacent charging station networked in a wireless manner is determined from the position parameter of the charging point from which the onboard sensor device makes the corresponding determinations, and from the relative position thereto of the charging point of the adjacent, non-networked charging station, wherein this position parameter is transmitted as part of the charging-relevant data. This information can look, for example, as follows: “Charging station two positions further to the right than the charging station with the identifier XY is currently occupied.”

The position parameters of the charging points of the charging stations of a charging park are preferably stored in at least one charging station, networked in a wired manner, of this charging park, for example, in a look-up table, where they can be read out if required and used for transmitting.

The present disclosure also includes developments of the method according to the present disclosure, which have features such as those already described in connection with the developments of the charging station information system according to the present disclosure. For this reason, the corresponding developments of the method according to the present disclosure are not described again herein.

The present disclosure also comprises the combinations of the features of the described embodiments. The present disclosure also comprises realizations that each have a combination of the features of a plurality of the described embodiments, provided that the embodiments were not described as mutually exclusive.

The embodiments described below are preferred embodiments of the present disclosure. In the embodiments, the described components of the embodiments each represent individual features of the present disclosure which should be considered in isolation and which each develop the present disclosure independently of one another. The disclosure is therefore also intended to comprise combinations of the features of the embodiments other than those presented. Furthermore, the described embodiments may also be supplemented by further, previously described features of the present disclosure.

In the figures, the same reference signs denote functionally identical elements.

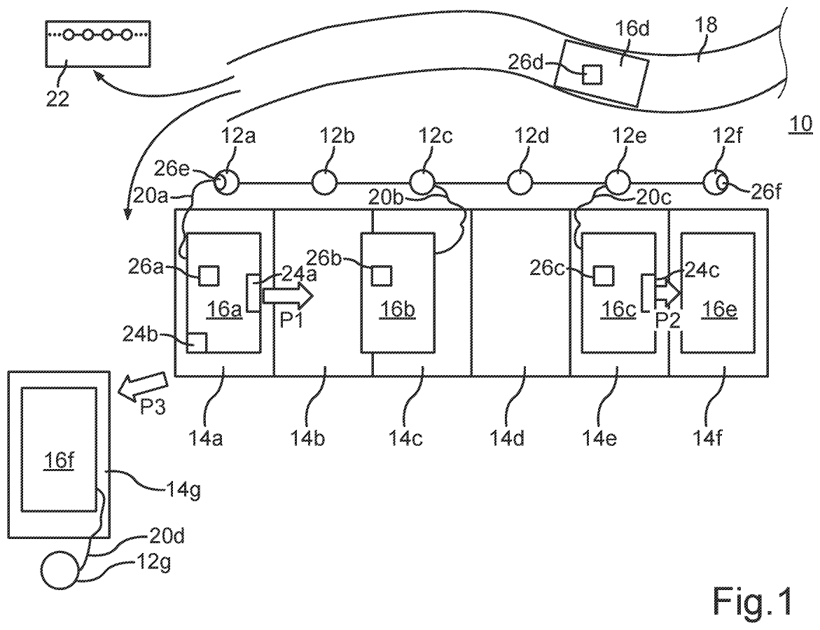

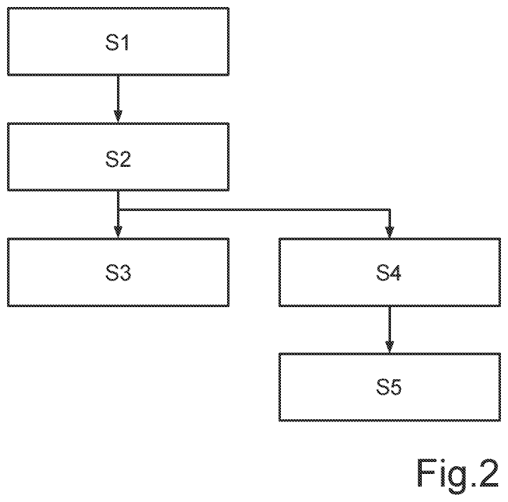

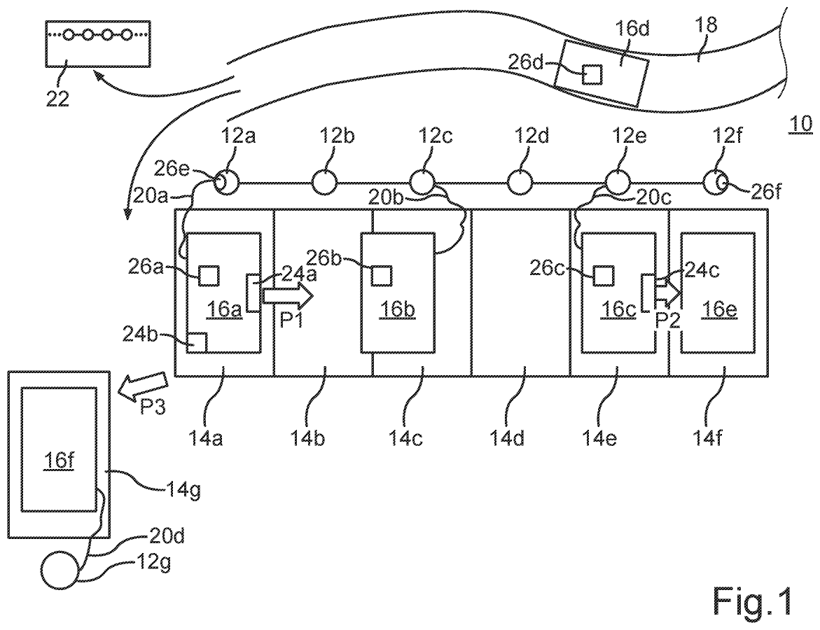

FIG. 1 shows a schematic representation to explain a charging station information system 10 according to the present disclosure for dynamically providing information about charging stations 12. Shown are a plurality of charging stations 12a to 12g with one charging point 14a to 14g assigned to each of said charging stations. In this context, “assigned” means that, in order to charge a motor vehicle from a specific charging station, the motor vehicle must be parked on the assigned charging point. In the embodiment shown, the charging stations 12a to 12f are networked in a wired manner. This does not apply to the charging station 12g. Each charging station 12a to 12g is assigned at least one identification parameter for unique identification of the charging station and one position parameter of the assigned charging point 14a to 14g. At least some of the charging stations 12a to 12g are preferably designed to determine their occupancy state. This is preferably achieved in that the charging station 12a to 12g determines the state “occupied” if it is coupled to a vehicle via a charging cable.

Furthermore, a plurality of vehicles 16 is provided, wherein the plurality of vehicles 16 comprises a first subset equipped with a communication device for wireless communication and a second subset not equipped with a communication device for wireless communication. In the present case, the first subset includes the vehicles 16a, 16b, 16c, and 16d. The vehicle 16d is a vehicle ready to be charged and traveling on a road 18 in a vicinity of the charging park 10. The vehicles 16e and 16f belong to the second subset.

The networked charging stations 12a to 12f are designed to exchange at least the respective identification parameter and the determined occupancy state as charging-relevant data. At least some of the charging stations 12a to 12f networked in a wired manner are designed to wirelessly transmit the charging-relevant data together with the respective position parameters of the assigned charging points 14 to vehicles of the first subset, in particular to the vehicle 16d. For this purpose, they have corresponding communication devices for wireless communication. “Position parameter” herein refers to an indication that allows a vehicle wanting to charge or its driver to drive to the charging point with pinpoint accuracy, i.e., for example, geographical information in degrees of longitude and latitude that can be processed by a navigation system of a motor vehicle and displayed on a display.

Additionally or alternatively, at least some of these charging stations 12a to 12f networked in a wired manner can be designed to transmit the charging-relevant data together with the position parameters of the assigned charging points 14 via the respective charging cable 20a, 20b, 20c to the respective vehicles 16a to 16c of the first subset connected thereto. At least one of these vehicles 16a to 16c is designed to wirelessly transmit the charging-relevant data together with the position parameters of the assigned charging points 14 to vehicles of the first subset, in this case the vehicle 16d.

A further charging park 22 with corresponding charging stations is indicated schematically. At least a plurality of charging stations in each charging park 10, 22 is preferably networked in a wired manner.

The charging-relevant data can also comprise at least one data element from the following group of data elements: position of at least one unoccupied charging station 12g networked in a wireless manner, position and time of the end of a current charging process of at least one charging station 12a to 12f networked in a wired manner, charging point size or actually available charging point size of at least one charging station 12a to 12g, and maximum possible charging capacity of at least one charging station 12a bis 12g.

As shown in the example of the vehicles 16a and 16c, they can be designed to determine the occupancy state of at least one adjacent charging point 14b, 14f, 14d assigned to another charging station, in particular a charging station 12g networked in a wireless manner, by means of at least one onboard sensor device 24a to 24c, as indicated by the arrows P1 to P3, and to transmit said occupancy state as part of the charging-relevant data. For example, the vehicle 16a can determine by means of its sensor device 24b whether the charging point 14g is occupied or not. With regard to the vehicle 16e, the assigned charging station 12f would exchange the occupancy state “unoccupied” with the other networked charging stations 12a to 12e, even though a vehicle 16e is actually parked on the charging point 14f—but without carrying out a charging process. As indicated by the arrow P2, the motor vehicle 16c can determine by means of the sensor device 24c that the charging point 14f is actually occupied by a vehicle and report this fact to the charging station 12e via the charging cable 20c. Said charging station can then communicate the actual charging state to the other networked charging stations 12a, 12b, 12c, 12d, and 12f.

The onboard sensor devices 24a to 24c can also be used to determine the actually available charging point size of at least one adjacent charging point assigned to another charging station, in particular a charging station networked in a wireless manner, and to transmit said charging point size as part of the charging-relevant data. In the present case, for example, the sensor device 24a of the motor vehicle 16a, as indicated by the arrow P1, can determine that the vehicle 16b protrudes into the charging point 14b and reduces its actual charging point size. This knowledge can be communicated via the charging cable 20a to the assigned charging station 12a and further transmitted from there to the other charging stations 12b to 12f networked in a wired manner. “Adjacent” in the sense of the present disclosure invention refers to charging points that are directly adjacent, a so-called first-generation charging point, or indirectly adjacent, i.e., one or two charging points are located in between, so-called adjacent second- or third-generation charging points. The decisive factor is that the onboard sensor device allows a statement to be made about the occupancy state or the actually available charging point size of the corresponding charging point, wherein said statement becomes worse the further away the charging point is located from the charging point of a user and the more occupied charging points are arranged in between.

The position parameter of a charging point of an adjacent charging station networked in a wireless manner can be determined from the position parameter of the charging point from which the onboard sensor device makes the corresponding determinations, and from the relative position thereto of the charging point of the adjacent, non-networked charging station, wherein this position parameter is transmitted as part of the charging-relevant data. The position parameters of the charging points of the charging stations of a charging park can be stored in at least one charging station, networked in a wired manner, of this charging park.

As already mentioned, the vehicles 16a, 16b, 16c, and 16d have communication devices 26a to 26d for wireless communication. As in the embodiment from FIG. 1, the charging stations 12a and 12f also have communication devices 26e and 26f for wireless communication.

With its communication device 26d, the vehicle 16d receives the charging-relevant data from at least one vehicle of the first subset; in the embodiment, these are the vehicles 16a, 16b, and 16c in the charging park 10. Alternatively, the charging-relevant data can be received from the charging stations 12a or 12f. While this is shown in detail in FIG. 1 with respect to the charging park 10, it applies in a corresponding manner to the charging park 22. The vehicle 16d thus receives the charging-relevant data of different charging parks 10, 22. In the case of an autonomously driving vehicle 16d, the vehicle can independently plan and carry out a charging stay on the basis of the charging-relevant data received. In the event that the vehicle 16d is user-controlled, the charging-relevant data can be displayed on a display device of the vehicle 16d, so that a user can plan a charging stay, wherein said user in this context can, for example, reserve a charging station from a certain point in time for a specific time period.

Such reservations can be transmitted from the vehicle 16d, whether in autonomous or user-controlled operation, via the communication device 26d to the charging stations 12a, 12f of the respective charging park equipped with communication devices and/or to the vehicles 26a to 26c equipped with communication devices and also transmitted within the framework of the charging-relevant data. Therefore, an occupancy state is not only a current occupancy state but also a future occupancy state.

The charging-relevant data are transmitted via wireless communication, preferably via GeoNetworking, in particular up to a distance of 5 km. This distance can be achieved using a plurality of network nodes.

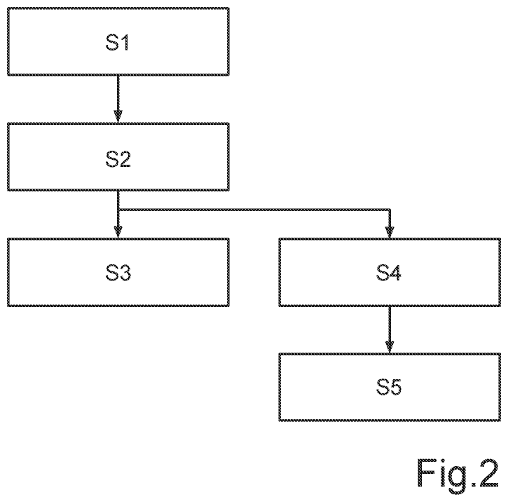

FIG. 2 shows a signal flow graph for an embodiment of the method according to the present disclosure. In step S1, a plurality of charging stations 12a to 12f of at least one charging park 10 is networked in a wired manner. In step S2, said charging stations 12a to 12f continuously exchange the respective identification parameter together with the determined occupancy state. In step S3, at least some of these charging stations 12a, 12f networked in a wired manner wirelessly transmit the charging-relevant data together with the respective position parameters of the assigned charging points to vehicles 16d of the first subset.

Alternatively, the method branches off in step S2 to step S4, according to which at least some of said charging stations networked in a wired manner transmit the charging-relevant data together with the position parameters of the assigned charging points via the respective charging cable to the respective vehicles of the first subset connected thereto. In step S5, at least one connected vehicle of the first subset then wirelessly transmits the charging-relevant data together with the position parameters of the assigned charging points to vehicles of the first subset.

1.-7. (canceled)

8. A charging station information system for dynamically providing information about charging stations comprising:
a plurality of charging stations, wherein each charging station is assigned at least one identification parameter and one position parameter of an assigned charging point, wherein at least one or more of the plurality of charging stations are configured to determine at least their occupancy state;
a plurality of vehicles, comprising a first subset of vehicles equipped with a communication device for wireless communication, and a second subset of vehicles not equipped with a communication device for wireless communication; and
a plurality of charging stations of at least one charging park are networked in a wired manner and designed to exchange at least a respective identification parameter and a determined occupancy state as charging-relevant data,
wherein at least one or more charging stations networked in a wired manner are configured to wirelessly transmit the charging-relevant data together with the respective position parameters of the assigned charging points to the first subset of vehicles.

9. The charging station information system of claim 8, wherein at least one connected vehicle of the first subset is configured to wirelessly transmit the charging-relevant data together with the position parameters of the assigned charging points to the first subset of vehicles.

10. The charging station information system of claim 8, wherein the plurality of charging stations are distributed over a plurality of charging parks, and wherein at least a plurality of charging stations in each charging park are networked in a wired manner.

11. The charging station information system of claim 8, wherein the charging-relevant data further comprises at least one data element from the following group of data elements:
position of at least one unoccupied charging station networked in a wireless manner;
position and time of the end of a current charging process of at least one charging station networked in a wired manner;
charging point size or actually available charging point size of at least one charging station; or
maximum possible charging capacity of at least one charging station.

12. The charging station information system of claim 8, wherein at least one vehicle coupled to a charging station is configured to determine the occupancy state of at least one adjacent charging point assigned to another charging station, the charging station being networked in a wireless manner, using at least one onboard sensor device, and configured to transmit the determined occupancy state as part of the charging-relevant data.

13. The charging station information system of claim 8, wherein at least one vehicle coupled to a charging station is configured to determine the available charging point size of at least one adjacent charging point assigned to another charging station, the charging station being networked in a wireless manner, using at least one onboard sensor device, and configured to transmit the determined charging point size as part of the charging-relevant data.

14. The charging station information system of claim 8, wherein a position parameter of a charging point of an adjacent charging station networked in a wireless manner is determined from the position parameter of the charging point from which the onboard sensor device makes a corresponding determination, and from a relative position thereto of the charging point of the adjacent, non-networked charging station, and wherein the position parameter is transmitted as part of the charging-relevant data.

15. The charging station information system of claim 8, wherein the position parameters of the charging points of the charging stations of a charging park are stored in at least one charging station, and networked in a wired manner.

16. A method for dynamically providing information about charging stations in a charging station information system, the method comprising:
assigning at least one identification parameter and one position parameter of the assigned charging point to each charging station of a plurality of charging stations;
determining, by at least one charging station at least the occupancy state;
equipping a first subset of vehicles with a communication device for wireless communication and not equipping a second subset of vehicles with a communication device for wireless communication;
networking a plurality of charging stations of at least one charging park in a wired manner;
transmitting by at least one charging station networked in a wired manner, a charging-relevant data with the position parameters of the assigned charging points via the respective charging to respective vehicles of the first subset of vehicles; and
transmitting by at least one charging station networked in a wireless manner, the charging-relevant data with the position parameters of the assigned charging points via the respective charging to respective vehicles of the first subset of vehicles,
wherein the charging-relevant data comprises at least the respective identification parameter and the determined occupancy state of the charging station.
